(19) United States
(12) Patent Application Publication
(10) Pub. No.: US 2011/0063423 A1
(43) Pub. Date: Mar. 17, 2011

(54) VIDEO PROCESSOR, VIDEO DISPLAYING SYSTEM AND VIDEO DISPLAYING METHOD

(75) Inventors: Masahiro YAMADA, Nishitama-gun (JP); Satoshi UCHIDA, Tachikawa-shi (JP)

(73) Assignee: Kabushiki Kaisha Toshiba, Tokyo (JP)

(21) Appl. No.: 12/884,029

(22) Filed: Sep. 16, 2010

(30) Foreign Application Priority Data
Sep. 16, 2009 (JP) 2009-213994

(51) Int. Cl. H04N 13/04

(52) U.S. Cl. 348/56; 348/55; 348/E13.001

(57) ABSTRACT

According to one embodiment, a video processor includes: an input module configured to receive a first image frame group in which an image capturing target is captured as a video image and a second image frame group in which the image capturing target is captured in the same timing as the first image frame group; an intermediate image generator configured to generate an intermediate image of continuous image frames in the first image frame group; a display controller; and a controller. The intermediate image generated by the intermediate image generator and the second image frame group are sequentially displayed alternately, and the intermediate image is seen in one part while the intermediate image is displayed and the second image frame group is seen in the other part while the second image frame group is displayed synchronously with the display controlled by the display controller.

### CROSS-REFERENCE TO RELATED APPLICATION

This application is based on and claims priority under 35 U.S.C. §119 from Japanese Patent Application No. 2009-213994 filed on Sep. 16, 2009.

### BACKGROUND

1. Field

One embodiment of the present invention relates to a video processor, a video displaying system and a video processing method, which can provide a stereoscopic video having a smooth motion to a user.

2. Description of the Related Art

In recent years, there has been proposed a stereoscopic video displaying system capable of displaying a stereoscopic video to a user. The stereoscopic video displaying system includes a stereoscopic video displaying method using shutter glasses as one of methods of causing the user to recognize a stereoscopic video.

In the stereoscopic video displaying method using the shutter glasses, an image for a left eye and an image for a right eye between which parallaxes are present are displayed on a single display device in different timings and an opening/closing operation of the shutters of the shutter glasses is controlled to cause a user to see the image for a left eye with only the left eye and to see the image for a right eye with only the right eye, thereby causing the user to recognize, as a three-dimensional object, a video displayed on the display device.

Moreover, there has been proposed an apparatus for performing a delay processing over an image frame of a two-dimensional (plane) video and generating three-dimensional (stereoscopic) videos of the image for a left eye and the image for a right eye, and converting the two-dimensional video into the three-dimensional video (see JP-A-11-98535).

In some cases in which a stereoscopic video is captured, an image for a left eye and an image for a right eye are captured by using two image capturing devices at the same time respectively. At this time, if the two image capturing devices are to capturing image frames at the same time and to alternately display them to a user, a time difference is made between the images for right and left eyes when they are displayed on the user though the respective image frames are images captured in the same timing. For this reason, referring to the image for a left eye and the image for a right eye which are to be displayed, videos are displayed in a different timing from a real time that the capturing is performed. In the case in which an image capturing target is being moved, particularly, the user sees the image capturing target as an awkward stereoscopic video.

### BRIEF DESCRIPTION OF THE DRAWINGS

A general architecture that implements the various features of the invention will now be described with reference to the drawings.

The drawings and the associated descriptions are provided to illustrate embodiments of the invention and not limited the scope of the invention.

FIG. 1 is an exemplary view showing an example of an overview of a stereoscopic video displaying system according to an embodiment of the invention;

FIG. 2 is an exemplary view showing an example of a capturing system of an image for a left eye and an image for a right eye according to the embodiment of the invention;

FIG. 3 is an exemplary block diagram showing an example of an internal structure of the stereoscopic video displaying system according to the embodiment of the invention;

FIG. 4 is an exemplary diagram showing an example of an image frame displayed on the video displaying apparatus and an opening/closing cycle of shutters of shutter glasses according to the embodiment of the invention;

FIG. 5 is an exemplary view showing an example of an image frame recognized visually by a user in the case in which an image generation processing is not performed by an image generator according to the embodiment of the invention;

FIG. 6 is an exemplary view showing an example of the image generation processing to be performed by the image generator according to the embodiment of the invention;

FIG. 7 is an exemplary view showing an example of an image frame recognized visually by the user in the case in which the image generation processing is performed by the image generator according to the embodiment of the invention; and

FIG. 8 is an exemplary flowchart showing an example of a processing to be performed by the video displaying apparatus according to the embodiment of the invention.

### DETAILED DESCRIPTION

Various embodiments according to the invention will be described hereinafter with reference to the accompanying drawings.

In general, according to one embodiment of the invention, an information processor and a control method which can automatically execute a predetermined program when an operator is absent.

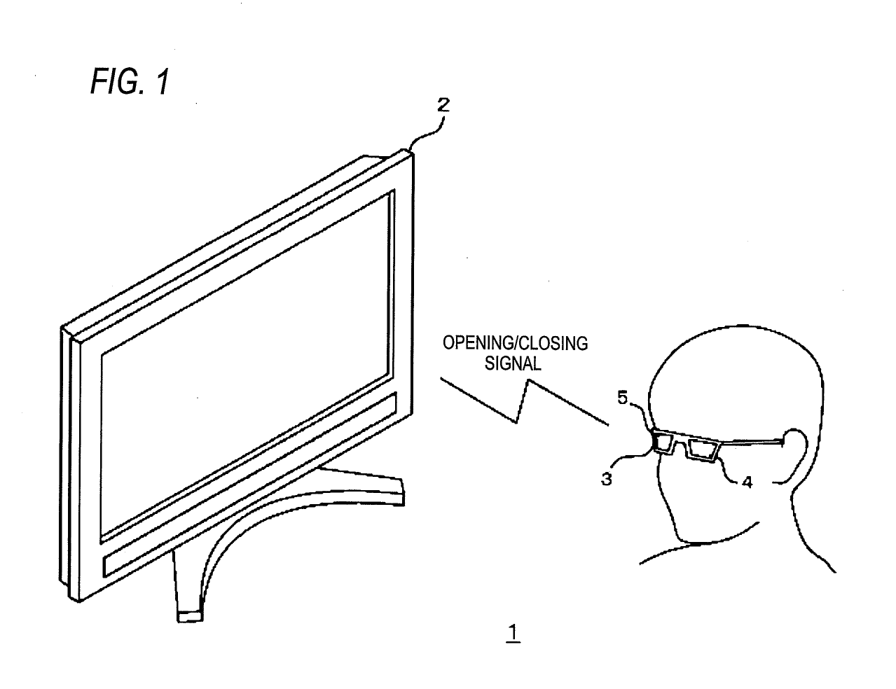

FIG. 1 is a view showing an example of an overview of a stereoscopic video displaying system 1 according to the embodiment. FIG. 1 shows the stereoscopic video displaying system 1, a video displaying apparatus 2 and shutter glasses 3.

The stereoscopic video displaying system 1 is provided with the video displaying apparatus 2 and the shutter glasses 3. A user wears the shutter glasses 3 and sees a video displayed on the video displaying apparatus 2, and can thus recognize the video as a stereoscopic video.

A person usually sees an object with left and right eyes which are placed in different positions, respectively. Parallaxes are present in images seen with the left and right eyes, respectively. By synthesizing images seen with the left and right eyes between which the parallaxes are present in a brain, the person can recognize, as a three-dimensional object, the object which is being seen. By seeing the images for left and right eyes between which the parallaxes are present with the respective eyes, accordingly, the user can synthesize the images in the brain, thereby gasping them as a three-dimensional object.

The video displaying apparatus 2 is a digital television, for example, and alternatively displays the images for left and right eyes between which the parallaxes are present. Consequently, it is possible to display a stereoscopic video on the user wearing the shutter glasses 3. Moreover, the video displaying apparatus 2 also has a function for generating a new image frame based on an image signal for a stereoscopic video display which is received.

The shutter glasses 3 have a lens 4 for a left eye and a lens 5 for a right eye. The lens 4 for a left eye and the lens 5 for a right eye are provided with shutters capable of performing shielding, respectively. Based on an opening/closing signal of the shutter received from the video displaying apparatus 2, the respective shutters are opened/closed in different timings to provide a stereoscopic video to the user. For example, when the image for a left eye is displayed on the video displaying apparatus 2, the shutter glasses 3 set the shutter of the lens 5 for a right eye into a closing state based on the opening/closing signal received from the video displaying apparatus 2 and cause only the left eye (one of the portions) of the user to see the image for a left eye. When the image for a right eye is displayed, moreover, the shutter of the lens 4 for a left eye is set into the closing state and only the right eye (the other portion) of the user is caused to see the image for a right eye.

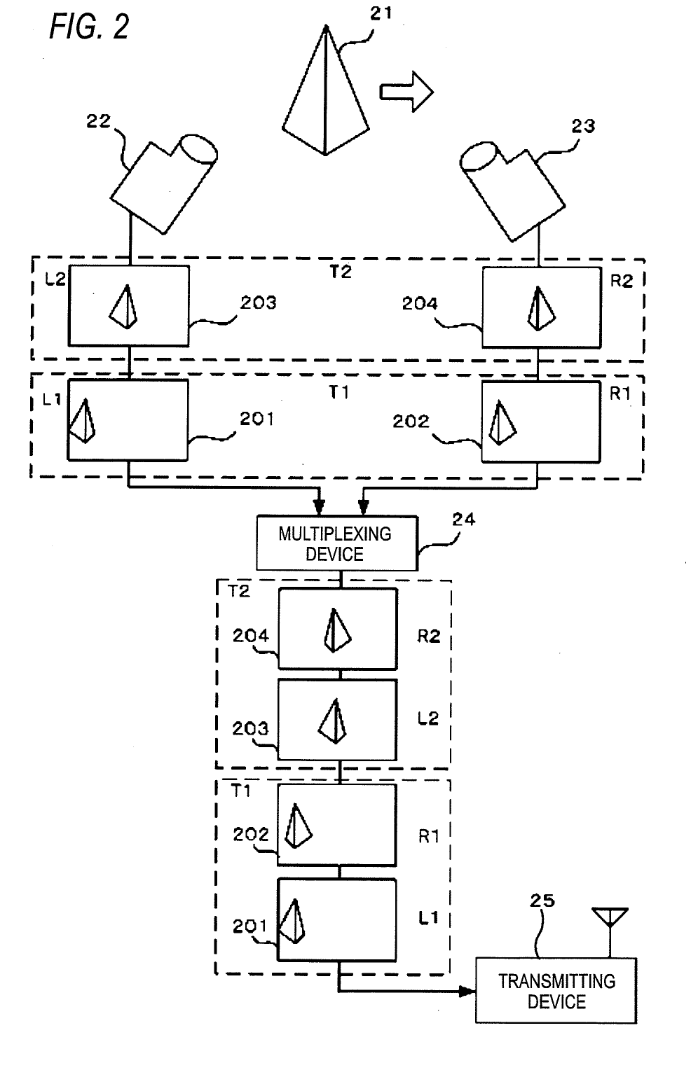

FIG. 2 is a view showing an example of a capturing system of an image for a left eye and an image for a right eye according to the embodiment. FIG. 2 shows an object 21, an image capturing device 22 for a left eye, an image capturing device 23 for a right eye, a multiplexing device 24, a transmitting device 25, and image frames 201 to 204.

The object 21 is an image capturing target of the image capturing device 22 for a left eye and the image capturing device 23 for a right eye and is a movable body which is moved in a direction of an arrow (a rightward direction) in FIG. 2.

The image capturing device 22 for a left eye and the image capturing device 23 for a right eye serve to capture an image of the object 21, and capture the image for a left eye and the image for a right eye, respectively. Moreover, capturing times for the images in the image capturing device 22 for a left eye and the image capturing device 23 for a right eye have the same timing (the images are captured at the same time).

The image frames 201 to 204 are captured by the image capturing device 22 for a left eye and the image capturing device 23 for a right eye. The image frame (L1) 201 and the image frame (R1) 202 are captured by the image capturing device 202 for a left eye and the image capturing device 23 for a right eye at a time T1 respectively, and the image frame (L2) 203 and the image frame (R2) 204 are captured by the image capturing device 22 for a left eye and the image capturing device 23 for a right eye at a time T2 respectively. The image frames 201 to 204 captured by the image capturing device 22 for a left eye and the image capturing device 23 for a right eye are transmitted to the multiplexing device 24, respectively.

The multiplexing device 24 has a function for multiplexing, into continuous serial data, the image frame for a left eye and the image frame for a right eye which are received from the image capturing device 22 for a left eye and the image capturing device 23 for a right eye in parallel and transmitting the same data to the transmitting device 25. In the embodiment, the multiplexing device 24 multiplexes the image frames and transmits the image frame captured earlier in order in time series. Referring to the image frames captured at the same time, the multiplexing device 24 arranges and multiplexes the image frame for a left eye earlier and the image frame for a right eye later and transmits them to the transmitting device 25.

The transmitting device 25 encodes digital data on the image frames which are received, and transmits the data as a broadcasting signal to a receiving device.

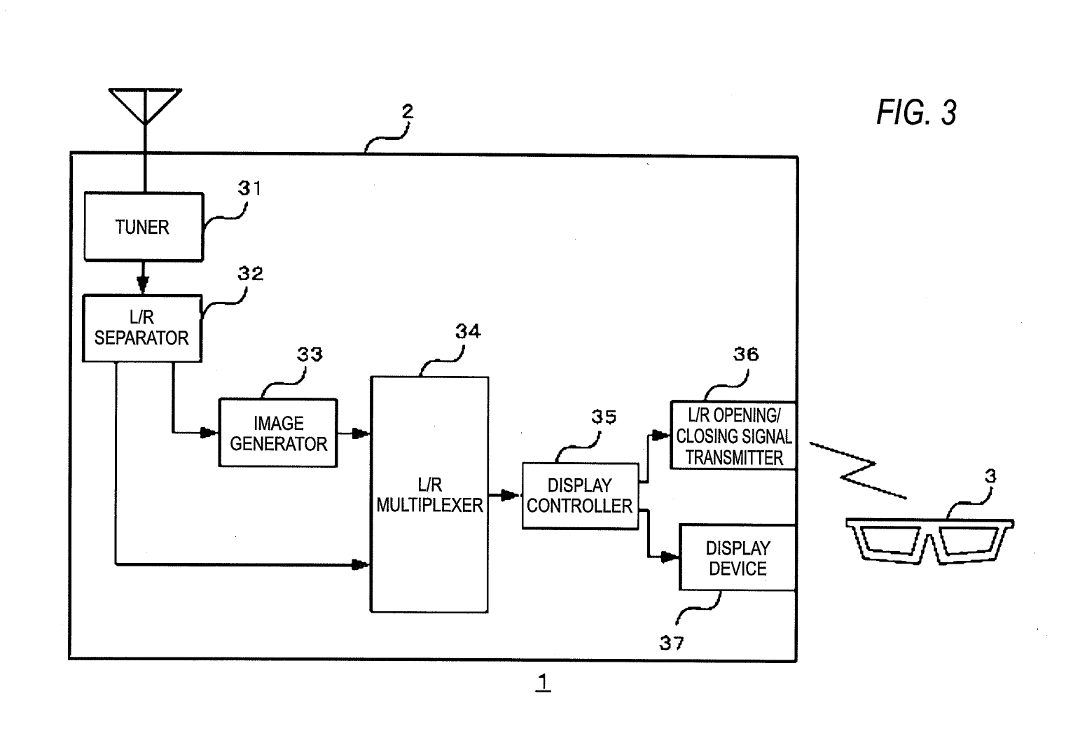

FIG. 3 is a block diagram showing an example of an internal structure of the stereoscopic video displaying system 1 according to the embodiment.

As shown in FIG. 3, the video displaying apparatus 2 has a tuner 31, an L/R separator 32, an image generator 33, an L/R multiplexer 34, a display controller 35, an L/R opening/closing signal transmitter 36 and a display device 37, and receives the broadcasting signal transmitted from the transmitting device 25 and can provide a stereoscopic video to a user.

The tuner 31 has a function as inputting means for performing a decode processing over the broadcasting signal received through an antenna and transmitted from the transmitting device 25 shown in FIG. 2 and converting the same signal into an image signal which can be displayed by the video displaying apparatus 2, and inputting the image signal into the video displaying apparatus 2.

The L/R separator 32 has a function for separating, into an image for a left eye and an image for a right eye, a video signal obtained by the conversion into a format which can be displayed by the video displaying apparatus 2 through the tuner 31. The L/R separator 32 separates the image for a left eye and the image for a right eye in response to the received video signal and transmits the images for left and right eyes to the L/R multiplexer 34 and the image generator 33, respectively.

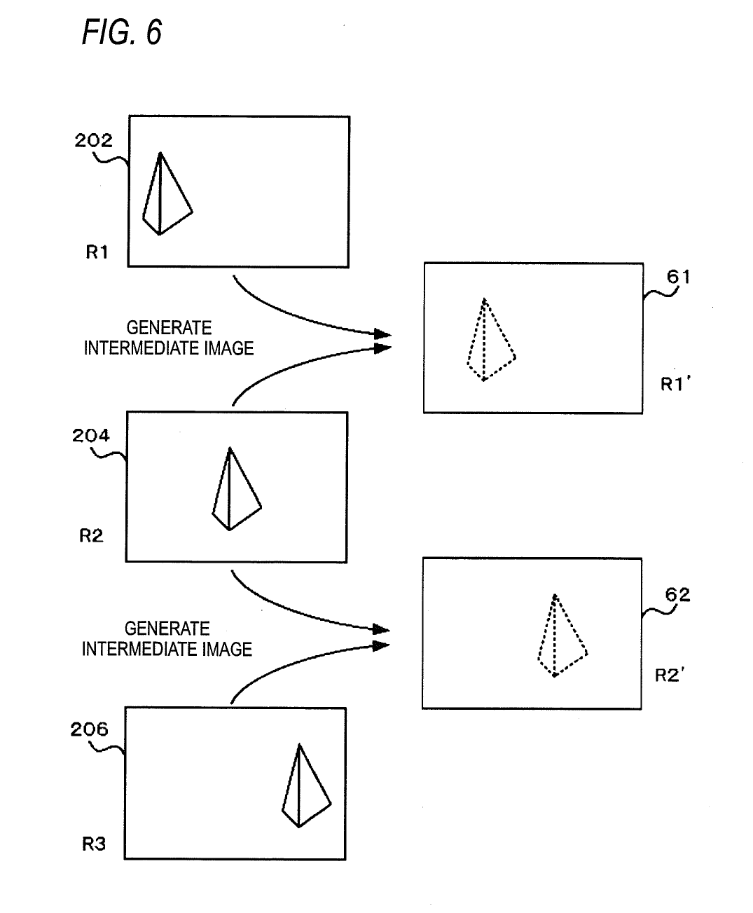

The image generator 33 receives the image for a right eye from the L/R separator 32 and generates a new image for a right eye at an intermediate time between times that respective image frames are captured based on a continuous image frame of the image for a right eye which is received. The image generation processing will be described below with reference to FIG. 6. The image generator 33 has a function for newly generating an image for a right eye and transmitting the same image for a right eye to the L/R multiplexer 34 in place of the image for a right eye which is received by the L/R separator 32.

The L/R multiplexer 34 has a function for arranging and multiplexing the image for a left eye which is received from the L/R separator 32 and the image for a right eye which is newly generated and is received from the image generator 33. Moreover, image data obtained by multiplexing through the L/R multiplexer 34 are transmitted to the display controller 35.

The display controller 35 has a function for displaying, on the display device 37, the image data received from the L/R multiplexer 34. At this time, the display controller 35 controls a display time for the image frame in the image data. A time required for displaying a single image frame is a half of a cycle in which the respective image frames are captured in the image capturing device 22 for a left eye and the image capturing device 23 for a right eye. For example, if the image capturing device 22 for a left eye and the image capturing device 23 for a right eye continuously capture images in a cycle of 1/60 second, the video displaying apparatus 2 switches the displayed image frame every 1/120 second. Moreover, the display controller 35 transmits a signal related to an opening/closing operation of the shutter glasses 3 to the L/R opening/closing signal transmitter 36 in such a manner that the shutter glasses 3 open/close the shutter synchronously with the switching of the image frame.

The L/R opening/closing signal transmitter 36 has a function as signal transmitting means for transmitting, to the shutter glasses 3, an opening/closing signal specifying the opening/closing operation of the shutter through infrared rays upon receipt of the signal related to the opening/closing operation of the shutter glasses 3 from the display controller 35. Although the transmission of the opening/closing signal through the infrared rays is illustrated in the embodiment, the invention is not restricted thereto but the opening/closing signal may be transmitted through another radio transmission. Moreover, the video displaying apparatus 2 and the shutter glasses 3 may be connected to each other through a cable capable of transmitting/receiving a signal.

The shutter glasses 3 open/close the shutter based on the opening/closing signal received from the L/R opening/closing signal transmitter 36.

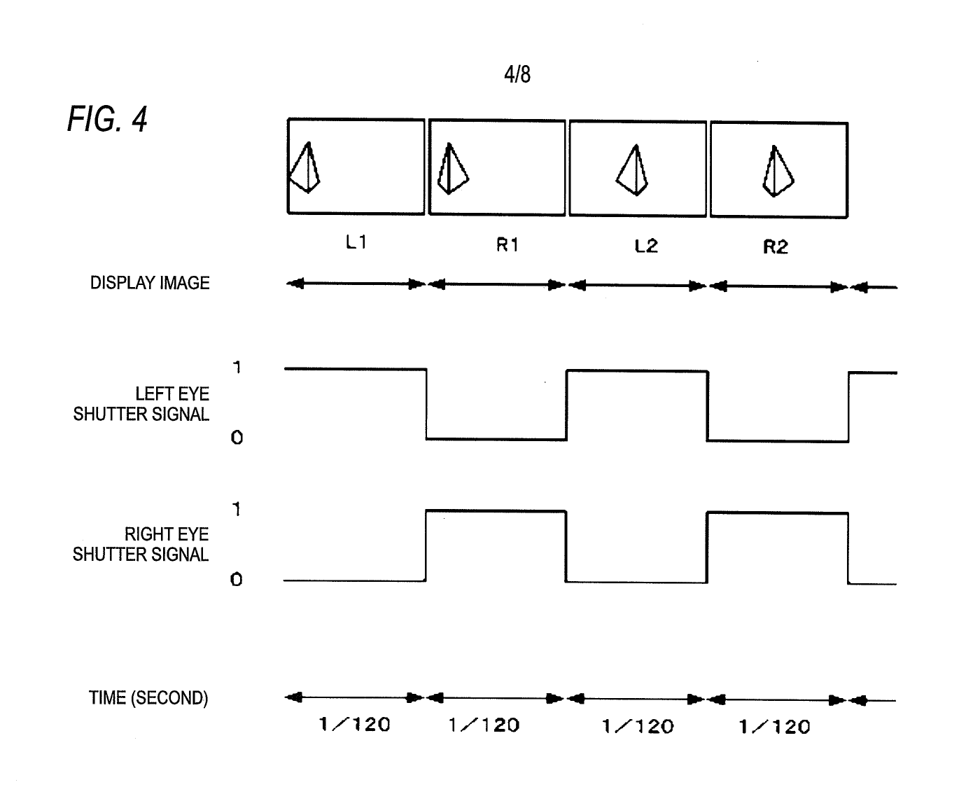

A cycle for switching the display on the display device 37 and opening/closing the shutter of the shutter glasses 3 will be described with reference to FIG. 4.

FIG. 4 is a diagram showing an example of an image frame displayed on the video displaying apparatus 2 and an opening/closing cycle of the shutter of the shutter glasses 3 according to the embodiment.

In the embodiment, respective image frames in image data are switched every 1/120 second (the respective image frames are displayed every 1/120 second).

In the embodiment, it is assumed that the shutters provided on the left and right lenses of the shutter glasses 3 are opened upon receipt of an opening/closing signal 1 and are closed upon receipt of an opening/closing signal 0. The L/R opening/closing signal transmitter 36 functions as control means for transmitting the opening/closing signals through infrared rays and controlling an opening/closing state of the shutters of the left and right lenses in the shutter glasses 3. As described above, the video displaying apparatus 2 transmits the opening/closing signal from the L/R opening/closing signal transmitter 36 to the shutter glasses 3 synchronously with switching of the image frame displayed on the display device 37. When the image for a left eye is displayed on the display device 37, the video displaying apparatus 2 sets the opening/closing signal of the shutter of the lens 4 for a left eye to be 1 and sets the opening/closing signal of the shutter of the lens 5 for a right eye to be 0, and causes only the left eye of the user to visually recognize the image for a left eye. When the image for a right eye is displayed, moreover, the video displaying apparatus 2 outputs the opening/closing signals with values thereof reversed as shown in FIG. 4, and causes only the right eye of the user to visually recognize the image for a right eye.

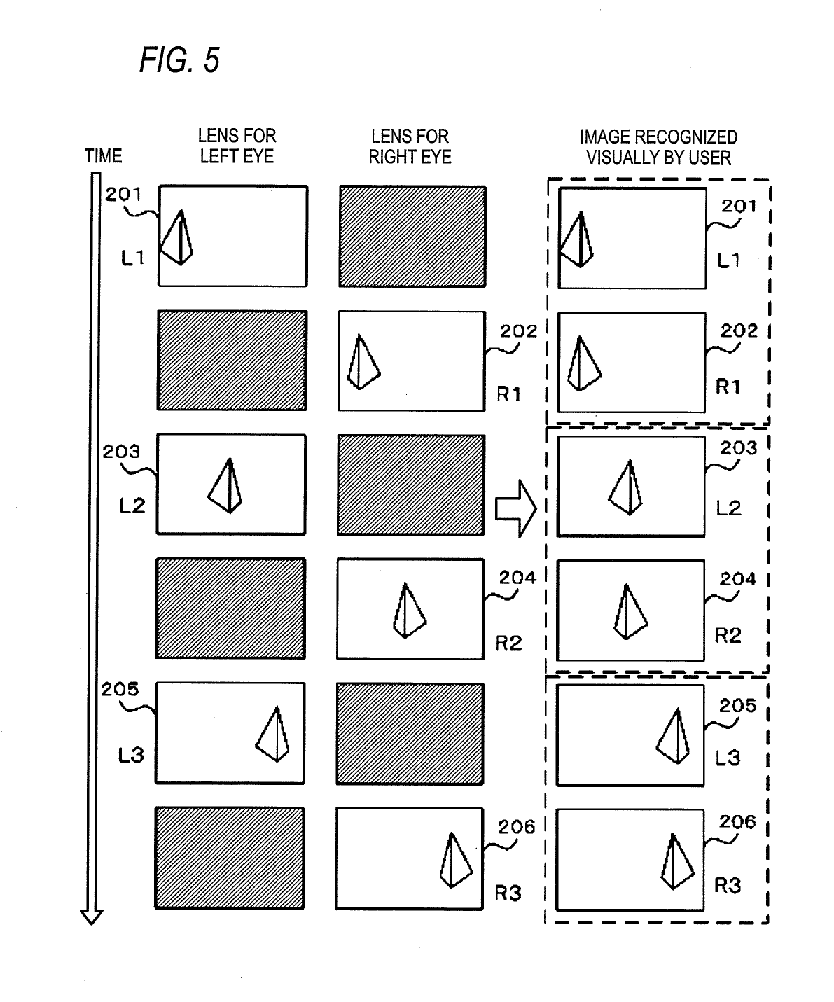

FIG. 5 is a view showing an example of the image frame recognized visually by the user in the case in which the image generation processing is not performed by the image generator 33 according to the embodiment.

FIG. 5 shows an image which can be visually recognized by the user through the lens 4 for a left eye, an image which can be visually recognized by the user through the lens 5 for a right eye and the united images which can be visually recognized by the user in order from a left side in a vertical direction in time series. In FIG. 5, an upper part is older and a lower part is newer. Moreover, a block shown in a slant line indicates a state in which the user cannot visually recognize anything with the shutter closed.

The image for a left eye and the image for a right eye are alternately displayed on the display device 37 in the video displaying apparatus 2, and the user visually recognizes the image for a left eye with the left eye and visually recognizes the image for a right eye with the right eye. The image for a left eye and the image for a right eye are united so that the image to be finally recognized by the user is set to be an image in a right part of FIG. 5 which can be visually recognized by the user. The parallaxes are present between the images for left and right eyes. Therefore, the user can recognize a video as a three-dimensional object. However, image frames in blocks surrounded by a broken line in the image which can be visually recognized by the user in FIG. 5 are captured at the same time, and the user visually recognizes, at different times, the image frames captured at the same time. For this reason, the user sees the image for a right eye which is delayed every half time of an image capturing cycle. Consequently, the shift gives an unnaturalness to a motion of an animation so that the animation is not smooth but is awkward.

FIG. 6 is a view showing an example of the image generation processing to be performed by the image generator 33 according to the embodiment.

In the embodiment, the image generator 33 carries out the image generation processing over the image for a right eye which is received. In the image generation processing, two image frames are compared with each other to obtain a motion vector in the image frames, and an image frame on an intermediate time point between image capturing times of the two image frames is generated based on the motion vector thus obtained. The image generation processing (a frame complementation processing) has been described in detail in JP-A-2008-067222 (corresponding to U.S. Publication No. 2008/0063289 A1), for example.

The image generator 33 carries out the image generation processing by using the image frame (R1) 202 captured at the time T1 and the image frame (R2) 204 captured at the time T2 and generates an image frame (R1′) 61 to be an intermediate image. Similarly, the image generator 33 carries out the image generation processing by using the image frame (R2) 204 captured at the time T2 and an image frame (R3) 206 captured at a time T3 and generates an image frame (R2′) 62 to be an intermediate image. Thus, the image generator 33 has a function for generating an image frame to be an intermediate image by using input continuous image frames. The image frame to be the intermediate image is expected to be almost the same as an image captured at a time between two image frames to which reference is made. Accordingly, the image frame (R1′) 61 is treated as an image frame captured by the image capturing device 23 for a right eye at an intermediate time between the times T1 and T2.

In other words, the image generator 33 transmits the generated image frame (R1′) 61 to the L/R multiplexer 34 in place of the image frame (R1) 202. The image generator 33 sequentially carries out the same processing for the image frame of the image for a right eye which is received, and transmits, to the L/R multiplexer 34, the image frame subjected to the processing.

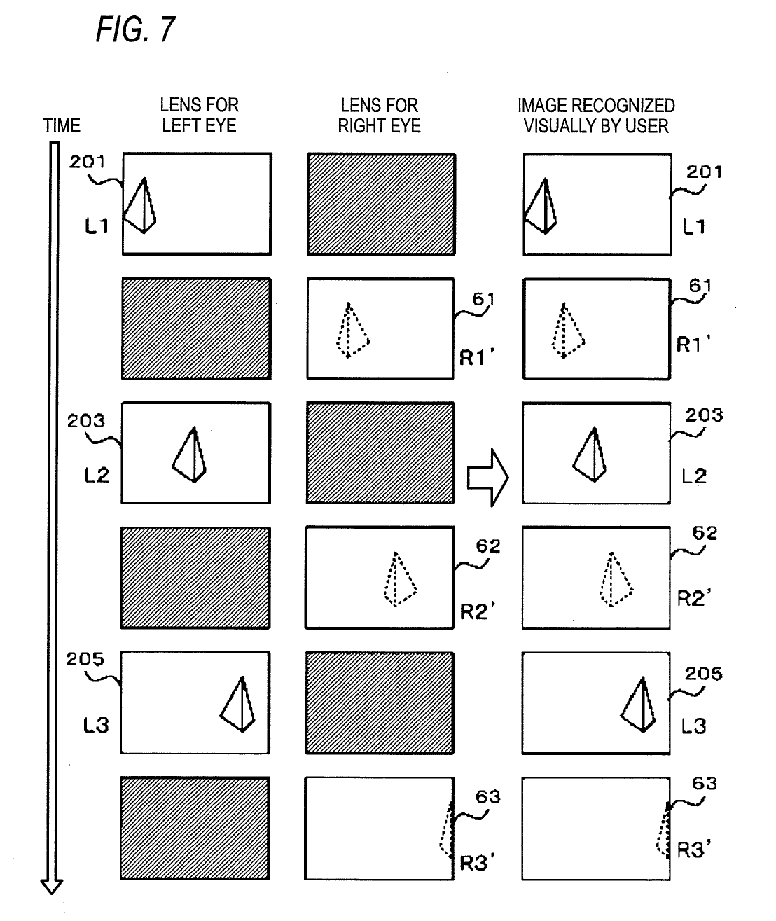

With reference to FIG. 7, description will be given to the image to be visually recognized by the user after the image frame is thus replaced by the image generator 33.

FIG. 7 is a view showing an example of an image frame to be visually recognized by the user in the case in which the image generation processing is performed by the image generator 33 according to the embodiment.

Although an image which can be visually recognized by the lens 4 for a left eye is not changed as shown in FIG. 7, an image which can be visually recognized by the lens 5 for a right eye is replaced by the image generator 33.

After the image generation processing (and a transmission of the generated image) is performed by the image generator 33, the user sees the image frame (R1′) 61 expected to be almost the same as the image frame captured at the intermediate time between the time T1 and the time T2 and generated by the image generator 33 between the image frame (L1) 201 captured at the time T1 and the image frame (L2) 203 captured at the time T2, for example. Therefore, the user can be prevented from seeing, at different times, the images captured at the same time as in the case in which the image generation processing of the image generator 33 is not performed, and furthermore, it is possible to display the image expected to be almost the same as an image in time series corresponding to a display time. Consequently, the user can see a stereoscopic video having a smoother motion than that in the case in which the image generation processing is not performed.

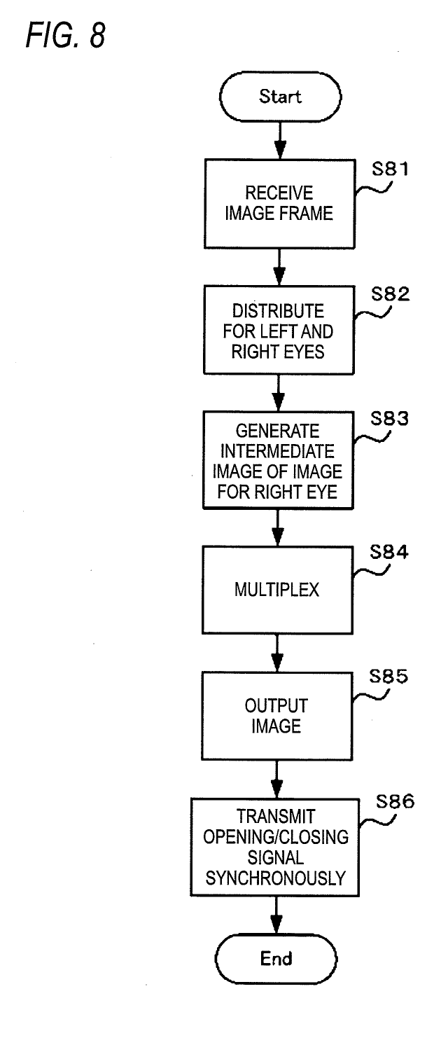

FIG. 8 is a flowchart showing an example of a processing to be performed by the video displaying apparatus 2 according to the embodiment.

First of all, the video displaying apparatus 2 receives a broadcast wave including image frames of an image for a right eye and an image for a left eye through the antenna (S81).

Next, the video displaying apparatus 2 decodes the broadcast wave which is received by the tuner 31, and extracts an image signal of the image frames from a decoded receiving signal. The L/R separator 32 receives the image frames thus extracted and separates the image frames into the image frame for a left eye and the image frame for a right eye (S82).

The L/R separator 32 transmits the image frame for a left eye in the separated image frames to the L/R multiplexer 34 and transmits the image frame for a right eye to the image generator 33. The image generator 33 carries out the image generation processing by using the image frame for a right eye which is received, generates an intermediate image on an intermediate time point between an image for a right eye on a certain time point and an image for a right eye which is linked to the image for a right eye, and transmits the generated image frame to the L/R multiplexer 34 in place of the image for a right eye which is received (S83).

The L/R multiplexer 34 multiplexes the image frame for a left eye which is received from the L/R separator 32 and the image frame generated by the image generator 33 (S84), and transmits the multiplexed image data to the display controller 35.

The display controller 35 displays the received image data on the display device 37 in order (S85). At this time, the L/R opening/closing signal transmitter 36 transmits an opening/closing signal to the shutter glasses 3 synchronously with the display of the image for a left eye and the image for a right eye on the display device 37. Consequently, the user can see the image for a left eye with only the left eye and can see the image for a right eye which is generated by the image generator 33 with only the right eye through the opening/closing operation of the shutters of the left and right lenses in the shutter glasses 3, and can view a stereoscopic video having a smooth motion.

Thus, the serial processing flow is ended.

Although the description has been given by taking, as an example, the state in which a video is input to the video displaying apparatus 2 through a broadcast wave in the embodiment, the invention is not restricted thereto but the video may be input by a storage medium such as a DVD (Digital Versatile Disc).

Although there has been taken the example in which the image generation processing is performed over the image for a right eye in the embodiment, moreover, the invention is not restricted thereto but reverse processings may be performed over the image for a right eye and the image for a left eye. Also in that case, it is possible to view a stereoscopic video having a smooth motion.

The stereoscopic video displaying system according to the embodiment can provide a stereoscopic video having a smooth motion to a user by replacing an image frame in an unnatural part in time series in image frames of a video to be displayed with a natural image frame and displaying the natural image frame.

Thus, according to the invention, there is provide a video processor, a video displaying system and a video displaying method which can provide a stereoscopic video having a smooth motion to a user.

The invention is not exactly restricted to the embodiment but the components can be modified and made concrete without departing from the scope in an executing stage. Moreover, it is possible to form various inventions by a proper combination of the components disclosed in the embodiment. For example, some of all the components described in the embodiment may be deleted. It is also possible to properly combine components in different embodiments.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. A video processor comprising:
an input module configured to receive a first image frame group in which an image capturing target is captured as a video image, and a second image frame group in which the image capturing target is captured synchronously with the first image frame group;
an intermediate image generator configured to generate an intermediate image of continuous image frames in the first image frame group by using a preceding frame and a current frame contained in the continuous image frames;
a display controller configured to control a display to sequentially display the generated intermediate image and the second image frame group alternately; and
a controller configured to control the intermediate image to appear in a first area while the intermediate image is displayed, and the second image frame group to appear in a second area while the second image frame group is displayed synchronously by the display controlled by the display controller.

2. The video processor of claim 1, wherein
the intermediate image generator is configured to calculate a motion vector in the continuous image frames and to generate the intermediate image based on the motion vector.

3. The video processor of claim 1, wherein
the video processor is configured to connect to shutter glasses, the shutter glasses being configured to transmit a signal and comprising shutters configured to shield videos corresponding to right and left eyes respectively when a user wears the shutter glasses, and
the controller comprises a signal transmitter configured to transmit, to the shutter glasses, an opening/closing signal in order to close one of the shutters corresponding to one of the eyes when the intermediate image is displayed by the display controller and to close the other shutter corresponding to the other eye when the second image frame group is displayed.

4. A video displaying system comprising:
an input module configured to receive a first image frame group in which an image capturing target is captured as a video image and a second image frame group in which the image capturing target is captured synchronously with the first image frame group;
an intermediate image generator configured to generate an intermediate image of continuous image frames in the first image frame group by using a preceding frame and a current frame contained in the continuous image frames;
a display configured to sequentially and alternately display the intermediate image generated by the intermediate image generator and the second image frame group; and
an output module configured to output the intermediate image in a first area and the second image frame group in a second area.

5. The video displaying system of claim 4, wherein
the intermediate image generator is configured to calculate a motion vector in the continuous image frames and to generate the intermediate image based on the motion vector.

6. The video displaying system of claim 4, wherein
the output module is shutter glasses configured to close a shutter corresponding to one of eyes when the display displays the intermediate image, and to close a shutter corresponding to the other eye when the display displays the second image frame group.

7. A video displaying method comprising:
inputting a first image frame group in which an image capturing target is captured as a video image and a second image frame group in which the image capturing target captured synchronously with the first image frame group;
generating an intermediate image of continuous image frames in the first image frame group by using a preceding frame and a current frame contained in the continuous image frames;
sequentially and alternately displaying the generated intermediate image and the second image frame group; and
outputting the intermediate image in a first area and the second image frame group in a second area.

8. The video displaying method of claim 7, further comprising:
calculating a motion vector in the continuous image frames; and
generating the intermediate image based on the motion vector.

9. The video displaying method of claim 7, comprising:
displaying the second image frame to a first eye and the intermediate image to a second eye; wherein,
if a user is wearing shutter glasses that comprise shutters configured to shield videos corresponding to the right or the left eye of the user,
a first shutter corresponding to one of the eyes is configured to close when the intermediate image is displayed, and
a second shutter corresponding to the other eye is configured to close when the second image frame group is displayed.
